(19) United States
(12) Patent Application Publication
(10) Pub. No.: US 2023/0082506 A1
(43) Pub. Date: Mar. 16, 2023

(54) BLOCKCHAIN-BASED E-BUSINESS PLATFORM FOR METAVERSE DECENTRALIZATION

(71) Applicant: Ruijin Qianniao Network Technology Co., Ltd., Ruijin (CN)

(72) Inventor: Huajun Liu, Ruijin (CN)

(73) Assignee: Ruijin Qianniao Network Technology Co., Ltd., Ruijin (CN)

(21) Appl. No.: 17/989,724

(22) Filed: Nov. 18, 2022

(30) Foreign Application Priority Data
Dec. 30, 2021 (CN) 202111641097.0

(51) Int. Cl. G06Q 20/12; G06Q 20/38; G06Q 20/40; G06Q 20/36

(52) U.S. Cl. CPC G06Q 20/1235; G06Q 20/389; G06Q 20/40; G06Q 20/36

(57) ABSTRACT

The present disclosure discloses a blockchain-based e-business platform for metaverse decentralization, and relates to the technical field of polymerization of diversified blockchain technologies. The e-business platform includes three blockchain technologies with different features: a commodity transaction blockchain system, a digital commodity ownership electronic authentication blockchain system, and a distributed storage blockchain system. Based on the high-performance transaction blockchain system, ultrahigh-speed transactions are achieved, and extremely low transaction fees are produced, so that a decentralization e-business transaction module becomes more effective. Based on the digital commodity ownership electronic authentication blockchain system, a commodity features with uniqueness, traceability, irreversibility, authorization and the like, and a decentralization e-business commodity management module becomes more efficient and simpler. The business platform combines diversified blockchain technologies, so that the blockchain technology has higher extensibility and a wider application range.

### TECHNICAL FIELD

The present disclosure relates to the technical field of polymerization of diversified blockchain technologies, specifically to a blockchain-based e-business platform for metaverse decentralization.

### BACKGROUND

In essence, metaverse is a process of virtualization and digitalization of the real world, which requires massive transformation on content production, economic system, user experience, physical world content, and the like. However, the metaverse is gradually developed. Supported by shared infrastructures, standards and protocols, the metaverse is finally formed by the continuous fusion and evolution of many tools and platforms. It provides immersive experience on the basis of an extended reality technology, generates a mirror image of the real world on the basis of a digital twin technology, builds an economic system on the basis of a blockchain technology. A virtual world is closely fused with the real world in terms of an economic system, a social system and an identity system to allow each user to perform content production and world editing.

At present, the metaverse is only used in the game world, but more values of the metaverse have not been developed and applied, such as work, entertainment and shopping. As a result, users are unable to get a new and efficient immersive life experience. Therefore, those skilled in the art propose a blockchain-based e-business platform for metaverse decentralization. The e-business platform for decentralization can endow digital assets with a consumable attribute. It has built a safe shopping channel to the metaverse.

### SUMMARY

For the shortcomings in the prior art, the present disclosure provides a blockchain-based e-business platform for metaverse decentralization, which solves the problems in the above background.

In order to achieve the above objective, the present disclosure is implemented by the following technical solution: The blockchain-based e-business platform for metaverse decentralization includes three blockchain technologies with different features, which are:

a commodity transaction blockchain system, configured to process a commodity transaction between a user and a merchant to achieve smart contract guarantee-free transactions;

a digital commodity ownership electronic authentication blockchain system, configured to make a unique ownership of a commodity and authenticate and transfer the commodity; and

a distributed storage blockchain system, configured to store and manage decentralized data, wherein a storage space is provided by a decentralization node supplier, which can effectively guarantee the data security and improve the data access efficiency.

In a further technical solution of the present disclosure, the commodity transaction blockchain system and the digital commodity ownership electronic authentication blockchain system are jointly developed on the basis of a high-performance blockchain network.

In a further technical solution of the present disclosure, data of the digital commodity ownership electronic authentication blockchain system is stored in the storage space of the distributed storage blockchain network.

In a further technical solution of the present disclosure, the e-business platform for decentralization further includes a digital asset type and a digital asset wallet; for the digital asset type, the merchant specifies which digital asset types are supported; and the user connects the digital asset wallet to the platform for transaction.

In a further technical solution of the present disclosure, during selection of the digital asset type supported by the merchant, a corresponding digital asset exchange rate is automatically selected, and the user selects the matched digital asset type for payment.

In a further technical solution of the present disclosure, the e-business platform for decentralization further includes a commodity retail mall and a commodity ownership market, wherein commodities in the commodity retail mall are all from the commodity ownership market; and the commodity retail mall and the commodity ownership market can use the commodity transaction blockchain system for transaction.

In a further technical solution of the present disclosure, the e-business platform for decentralization further includes a commodity structure, wherein the commodity structure is composed of a front view of the commodity, the price of the commodity, an inventory pledge, a payment mode, commodity descriptions, and the like.

In a further technical solution of the present disclosure, for inventory pledge, the merchant submits a pledge amount according to the actual operation requirements, and a calculation formula of the pledge amount is: pledge amount=commodity selling price*(inventory quantity+after-sales base).

### BENEFICIAL EFFECTS

The present disclosure provides a blockchain-based e-business platform for metaverse decentralization. Compare with the prior art, the blockchain-based e-business platform has the following beneficial effects:

The business platform combines diversified blockchain technologies, so that the blockchain technology has higher extensibility and a wider application range. Based on the high-performance transaction blockchain system, ultrahigh-speed transactions can be achieved, and extremely low transaction fees are produced, so that a decentralization e-business transaction module becomes more effective.

Due to the three attributes that are endowed by the digital commodity ownership electronic authentication blockchain system to commodities: I, a commodity ownership attribute; II, a commodity authentication attribute; and III, a commodity selling right attribute, the commodities are unique, traceable, irreversible, authorizable and the like, so that the commodities can be shaped into a mechanism and order, making commodity management simpler and more efficient. By the combination of multiple parallel blockchain technologies, the platform can not only achieve retail, but also integrate wholesale/design/retail.

The data of the platform is stored in the storage space provided by the distributed storage blockchain network. The distributed storage can effectively ensure the data security, improve the data access efficiency, and is no longer limited to the problems caused by centralization congestion. Data can be accessed and retrieved nearby, and the problem of data delay is greatly relieved. The transaction mode is also a more open and secure smart contract guaranteed-free transaction, and there are a variety of digital asset types for selection, as long as the digital asset types supported by the commodities can be automatically converted to the designated digital asset exchange rate for transactions. Since the platform does not manage users' assets, users can manage their digital assets more securely and conveniently by connecting the digital asset wallet to the platform.

Both merchants and customers should register accounts on the platform to provide different service contents and rights protection. There are two important steps for putting commodities on the shelves in the retail mall: First, the commodities need to have the unique ownership first, and then enter the commodity ownership market. Second, after entering the commodity ownership market, the commodities with the commodity ownership can be directly put on the shelves of the commodity retail mall. If the commodities have no commodity ownership, an authorization or ownership can be purchased in the commodity ownership market, and then the commodities can be put on the shelves in the commodity retail mall for sales. This mechanism can effectively manage the commodities and extend the creation value of the commodities, so as to improve the system availability in a more diversified way.

### BRIEF DESCRIPTION OF THE DRAWINGS

FIG. 1 is a block diagram of a basic constitution of the present disclosure;

FIG. 2 is a flow chart of a commodity transaction behavior of the present disclosure;

FIG. 3 is a flow chart of an ownership transaction behavior of the present disclosure;

FIG. 4 is a flow chart of making ownerships of commodities and putting the commodities on shelves; and

FIG. 5 is a structural block diagram of a commodity of the present disclosure.

In the drawings: 1: high-performance blockchain network; 11: commodity transaction blockchain system; 12: digital commodity ownership electronic authentication blockchain system; 2: distributed storage blockchain network; 3: commodity retail mall; 4: commodity ownership market; 5: digital assets wallet; 6: supported digital asset type; and 7: commodity structure.

### DETAILED DESCRIPTION OF THE EMBODIMENTS

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments. All other embodiments obtained by those of ordinary skill in the art based on the embodiments in the present disclosure without creative work shall fall within the protection scope of the present disclosure.

Referring to FIG. 1 to FIG. 5, according to one technical solution of the present disclosure, a blockchain-based e-business platform for metaverse decentralization includes three blockchain technologies with different features, which are:

a commodity transaction blockchain system 11, configured to process a commodity transaction between a user and a merchant to achieve no-guarantee transactions of a smart contract;

a digital commodity ownership electronic authentication blockchain system 12, configured to make a unique ownership of a commodity and authenticate and transfer the commodity; and

a distributed storage blockchain system 2, configured to store and manage decentralized data, wherein a storage space is provided by a decentralization node supplier, which can effectively guarantee the data security and improve the data access efficiency.

The data of the digital commodity ownership electronic authentication blockchain system 12 is stored in the storage space of the distributed storage blockchain network 2. The distributed storage can effectively ensure the data security, improve the data access efficiency, and is no longer limited to the problems caused by centralization congestion. Data can be accessed and retrieved nearby, and the problem of data delay is greatly relieved.

The commodity transaction blockchain system 11 and the digital commodity ownership electronic authentication blockchain system 12 are jointly developed on the basis of a high-performance blockchain network 1.

In addition, the e-business platform for decentralization further includes a digital asset type 6 and a digital asset wallet 5. For the digital asset type 6, a merchant specifies which digital asset types are supported; and a customer connects the digital asset wallet 5 to the platform for transaction. During selection of the digital asset type supported by the merchant, a corresponding digital asset exchange rate is automatically selected, and the user selects the matched digital asset type for payment. The e-business platform for decentralization further includes a commodity retail mall 3 and a commodity ownership market 4. Commodities in the commodity retail mall 3 are all from the commodity ownership market 4. The commodity retail mall 3 and the commodity ownership market 4 can use the commodity transaction blockchain system 11 for transaction. A rank display mechanism and a promotion mechanism of the commodity ownership market are not completely consistent with those of the commodity retail mall. The promotion mechanism of the commodity ownership market mainly adopts a periodic stall auction method, while the commodity retail mall mainly adopts real-time bidding transaction fee+discount rate.

An inventory pledge mechanism of the commodity retail mall: According to the proportion of sales inventory quantity, a larger quantity indicates a higher pledge amount [commodity selling price*(inventory quantity+after-sales base)=pledge amount]. The pledge mechanism is mainly configured to protect the rights and interests of customers and provide high-quality after-sales treatment capacity. It is also a promotion transaction fee deducted after the platform promotion succeeds. In case of low stock, the promotion service will be automatically stopped.

The rank display mechanism and the promotion mechanism of the commodity retail mall: There are two display modes of the promotion mechanism: I, [global/plate] commodities cover a main display center and other plates; II, [keyword] commodities cover a keyword search area. The two display modes can adopt the same promotion mechanism: I, set a promotion fee: the fee is less than or equal to the commodity selling price. II, set a transaction fee and a discount rate: The transaction fee includes node consumption and the promotion fee (to benefit the platform), and the discount rate is set to benefit the customer (to improve the conversion rate). Benefiting the platform can improve the commodity exposure rate, and the promotion of searching of keywords can be more refined.

A default ranking mechanism of commodities: an allocation scheme of rank weight values: [commodity heat value<commodity score percentage value<comprehensive quality score value]. The commodity heat value is a value of a trading volume. The commodity score percentage value mainly refers to a comprehensive score from the customers on commodities. The comprehensive quality score value is a ratio of positive words to negative words, which is generated by means of performing big data analysis on historical comments by recording words that appear more frequently, among which, factors such as collection, following and like are also comprehensively considered.

An infringement reporting mechanism of the commodity ownership market: I, preemption of the ownership: the merchants negotiate it privately or hand over it to the court or arbitration institution for handling to require the preemptor to transfer the ownership (the platform has no right to transfer the ownership, but can take the ownership off the shelf). II, highly similar pictures: if the merchants submit the patent or copyright certificates, the platform takes the commodity ownership off the shelf where appropriate. III, brand infringement: if a commodity ownership includes unauthorized brand logos, it will be deemed as the sale of fake goods, and the account of the merchant will be closed forever. The commodity ownership is taken off the shelf. All commodities associated with the infringement will be take off the shelf.

After-sales disputes of commodities: I, the merchant violates its promise and the commodities have a quality problem, which will be judged by public jury+official judge. If it is determined that the merchant is the tort-feasor, the corresponding pledge amount will be deducted, and the merchant also has to pay part of the commission for the public jury (in serious cases, the commodity or the ownership is taken off the shelf). II, if a received real object is unauthentic, the customer is required to submit valid evidences. If the real object is identified as a fake goods, the account of the merchant will be closed permanently. The ownership of the commodity will be taken off the shelf, and the pledge amount of the commodity will be zeroed, and fraudulent sellers will be ordered to quit.

A fake transaction handling plan; I, a fake transaction screening mechanism: [valid sales volume weight evaluation+increase of false transaction cost+increase of diversified comprehensive ranking. II, fake transaction punishment mechanism: the commodity will be subjected to authority downgrading for (N) days in light cases, while the commodities will be taken off the shelf in severe cases.

A transaction dispute service center (staff service): After the public jury make comments on the dispute, the official judge will make a comprehensive decision. If there is no public jury comments, the official judge will make a full decision. The public jury has to make a valuable comment with (N) or more words. If it is the responsibility of the merchant, the innocent party will get a commission and its comprehensive score will be increased. The official judge will decide the winner. If it is not the responsibility of the merchant, the public jury makes a wrong judgment, and the comprehensive score of the public jury will be reduced, and the opportunity of using a jury will be reduced. The platform will publicly display the judgment accuracy of the public jury. All users of the platform can participate in the public jury and make contributions to improving the fairness and impartiality of the platform.

In order to further elaborate the present disclosure, the roles and tools involved are set as follows:

User A (Customer)

A customer registers his account on the platform. The platform provides the customer with a shopping behavior service in the commodity retail mall, service contents including: commodity browsing/consulting, commodity trading, order inquiry, after-sales rights defending, commodity evaluation and other basic functional needs.

User B (Merchant)

The merchant registers an account on the platform. The platform provides the merchant with services such as making commodity ownership, selling ownership, selling commodity authorization, purchasing commodity authorization, and putting commodities to commodity retail markets. Service contents include: customer ownership service, commodity ownership management, commodity authorization management, commodity order management, commodity retail management, user after-sales management, merchant digital asset address management, commodity promotion management, commodity ownership promotion management, and other basic functional requirements.

### Embodiment 1

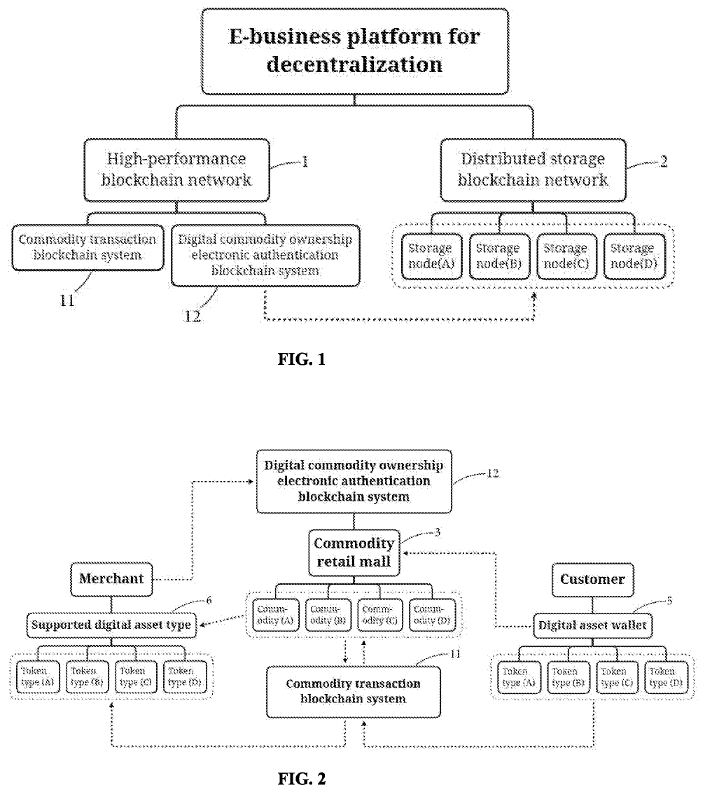

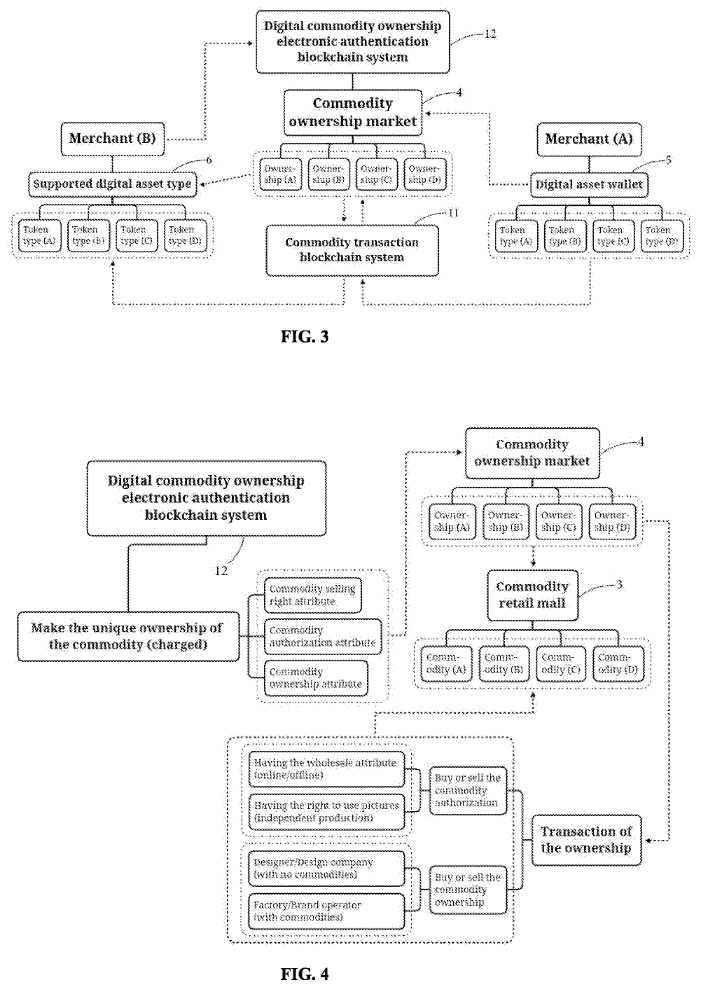

Referring to FIG. 2, first of all, the merchant uses the digital commodity ownership electronic authentication blockchain system 12 to make the commodity ownership and then put the commodity on the shelf in the commodity retail mall 3 for sales, and provides a collection address list of the digital asset type 6 supported by the commodity transaction. After the customer logs on to the platform, the customer connects the digital asset wallet 5 to the platform, browse and select a commodity in the commodity retail mall 3, submits an order and selects the supported digital asset type 6. The system will automatically convert the exchange rate for transaction. After receiving the order, the merchant delivers the commodity according to customer's requirements for the commodity, the address and other relevant information. The customer clicks Confirm after receiving the commodity to complete the transaction. Because of the inventory pledge mechanism of the commodity retail mall, the customer still has the opportunity to protect his legal rights and interests after confirming the transaction, thus preventing the risk of the merchant's making off with money.

### Embodiment 2

Referring to FIG. 3, first, merchant B enters the commodity ownership market 4 after making the ownership of the commodity through the digital commodity ownership electronic authentication blockchain system 12.

After logging on to the platform, merchant A connects digital asset wallet 5 to the platform. Merchant A selects the commodity ownership in the commodity ownership market 4, and chooses to wholesale or purchase the right to use pictures or purchase the commodity ownership. Of course, merchant B needs to support the choice. After receiving the order, merchant B shall deliver the commodity according to merchant A's wholesale requirements, address and other relevant information, or authorize the right to use pictures of the commodity, or transfer the commodity ownership. Merchant A completes the transaction after receiving the commodity, or the right to use pictures, or the commodity ownership.

### Embodiment 3

Referring to FIG. 4, the merchant makes the commodity ownership through the digital commodity ownership electronic authentication blockchain system 12. The unique ownership of the commodity has three attributes: I, a commodity ownership attribute, II, a commodity authorization attribute, and III, a commodity sales right attribute. After the ownership making is completed, the merchant enters the commodity ownership market, and then conducts ownership transactions (selling/authorization), or directly put the ownership on the shelf of commodity retail mall for sales.

### Embodiment 4

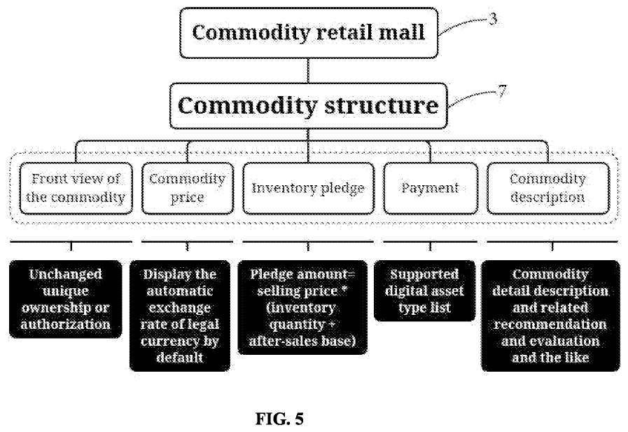

Referring to FIG. 5, when putting a commodity onto the shelf, the merchant edits the commodity through the basic framework of the commodity structure 7. The front view of the commodity cannot be edited by default, but auxiliary images can be added or edited. By default, the commodity price is displayed in legal currency. For the inventory pledge, a pledge amount is submitted according to actual operation requirements. The calculation formula of the pledge amount is: pledge amount=commodity selling price*(inventory quantity+after-sales base). For the payment, the merchant specifies which digital asset types are supported. The commodity description, as its name implies, is a detailed and functional description of the commodity, including functions such as commodity related recommendation and commodity evaluation.

It should be noted that in this context, relational terms such as first and second are used merely to distinguish one entity or operation from another entity or operation, instead of necessarily requiring or implying that these entities or operations have any of these actual relationships or orders. Furthermore, terms “include”, “including” or any other variants are meant to cover non-exclusive inclusions, so that a process, method, object or device that includes a series of elements not only includes those elements, but also includes other elements which are not definitely listed, or further includes inherent elements of this process, method, object or device.

Although the embodiments of the present disclosure have been shown and described, it will be understood by those of ordinary skill in the art that various changes, modifications, substitutions, and variations can be made to these embodiments without departing from the principle and spirit of the present disclosure. The scope of the present disclosure is defined by the attached claims and their equivalents.

1. A blockchain-based e-business platform for metaverse decentralization, comprising three blockchain technologies with different features:
a commodity transaction blockchain system (11), configured to process a commodity transaction between a user and a merchant to achieve smart contract guarantee-free transactions;
a digital commodity ownership electronic authentication blockchain system (12), configured to make a unique ownership of a commodity and authenticate and transfer the commodity; and
a distributed storage blockchain system (2), configured to store and manage decentralized data, wherein a storage space is provided by a decentralization node supplier, which can effectively guarantee the data security and improve the data access efficiency.

2. The blockchain-based e-business platform for metaverse decentralization according to claim 1, wherein the commodity transaction blockchain system (11) and the digital commodity ownership electronic authentication blockchain system (12) are jointly developed on the basis of a high-performance blockchain network (1).

3. The blockchain-based e-business platform for metaverse decentralization according to claim 1, wherein data of the digital commodity ownership electronic authentication blockchain system (12) is stored in the storage space of the distributed storage blockchain network (2).

4. The blockchain-based e-business platform for metaverse decentralization according to claim 1, further comprising a digital asset type (6) and a digital asset wallet (5); for the digital asset type (6), the merchant specifies which digital asset types are supported; and the user connects the digital asset wallet (5) to the platform for transaction.

5. The blockchain-based e-business platform for metaverse decentralization according to claim 4, wherein during selection of the digital asset type supported by the merchant, a corresponding digital asset exchange rate is automatically selected, and the user selects the matched digital asset type for payment.

6. The blockchain-based e-business platform for metaverse decentralization according to claim 1, further comprising a commodity retail mall (3) and a commodity ownership market (4), wherein commodities in the commodity retail mall (3) are all from the commodity ownership market (4); and the commodity retail mall (3) and the commodity ownership market (4) can use the commodity transaction blockchain system (11) for transaction.

7. The blockchain-based e-business platform for metaverse decentralization according to claim 1, further comprising a commodity structure (7), wherein the commodity structure (7) is composed of a front view of the commodity, the price of the commodity, an inventory pledge, a payment mode, commodity descriptions, and the like.

8. The blockchain-based e-business platform for metaverse decentralization according to claim 7, wherein for inventory pledge, the merchant submits a pledge amount according to the actual operation requirements, and a calculation formula of the pledge amount is: pledge amount=commodity selling price*(inventory quantity+after-sales base).
